(19) United States
(12) Patent Application Publication
(10) Pub. No.: US 2012/0254013 A1
(43) Pub. Date: Oct. 4, 2012

(54) METHOD AND SYSTEM FOR MANAGING SECURITY UNIT ASSOCIATED WITH INTELLECTUAL PROPERTY ASSETS

(76) Inventors: Chun Woei Chee, Chinatown Plaza (SG); Mark Tow-Siew Hon, The Diary Farm (SG)

(21) Appl. No.: 13/469,374

(22) Filed: May 11, 2012

Related U.S. Application Data
(63) Continuation of application No. PCT/SG2009/000425, filed on Nov. 13, 2009.

(51) Int. Cl. G06Q 40/04; G06Q 50/00

(52) U.S. Cl. 705/37

(57) ABSTRACT

A new method and system is presented for facilitating the lodgement, storage, issue, custody, record, transfer and trade of one or more security units associated with intellectual property (“IP” assets. The invention includes an input device for receiving a request for information from a querying device for assessment of the information on IP assets. The systems has a querying mechanism for requesting and receiving information various third party devices. An output device of the system presents at information gathered from its database. In an embodiment of the system, the information from the querying device is related to right-to-use, encumbrances, ownership, and price of the trading security on IP assets.

### CROSS-REFERENCE TO RELATED APPLICATION

This application is a continuation of International Patent Application No. PCT/SG2009/000425, filed Nov. 13, 2009, the entire disclosures of which is hereby incorporated by reference.

### FIELD OF THE INVENTION

The present invention relates to a method and system for the lodgement, storage, issue, custody, record, transfer and trade of one or more security units associated with intellectual property (“IP”) assets.

### BACKGROUND

Intellectual property assets, including patents, trademarks, copyrights, trade secrets, and a variety of other assets, are among the most important assets of businesses. Recently, intellectual property assets have gown in importance relative to other assets of businesses such as plant and equipment, access to natural resources, or capital. These other assets have become increasingly fungible and commoditized due to globalization and modernization of the world economy. In contrast, due to the increasing speed of technological change in the economy, particularly technological change arising from the widespread use of computers and new telecommunications technologies including the internet, patents, trademarks and copyrights have especially increased in their importance to companies.

While patents can be of great value, only relatively few patents are effectively exploited by the patentees (or the assignees of the patents) so that the patents actually achieve their maximum value as assets. Many patents are held by companies that do not make, use or sell products (or services) embodying the technologies claimed in the patents. Further, relatively few patents are diligently enforced against other companies or licensed in the most profitable fashion possible, to all of or even a few of the companies (or other parties) who would be interested in licensing those patents and willing to pay for such licenses. Additionally, very few companies seriously investigate the possibility, of selling their patents. There are several reasons for the failure of patent-holders to maximize the value of their patents through licensing or sale. Some patents are held by companies which for business reasons have chosen not to make, use or sell technologies covered by the patents, even though there is a market for such technologies that other companies would be interested in exploiting if they were able to license or purchase those same patents. More commonly, many patent holders fail to realize, due to bad judgment or ignorance (or simply due to the complexity and uncertainties that exist in the financial valuation of patents), the potential value of their patents. For example, many patents that in fact cover a variety of technologies in a variety of industries are held by companies, or only licensed to companies, which make, use or sell products embodying only a small subset of those technologies within only a subset of those industries. Typically, such patent-holders are not aware of all of the potential applications of their patented technologies.

By providing a patentee with an ability to preclude other parties from making, using or selling a particular technology, for a limited time, a patent can provide the patentee with a very secure and valuable competitive advantage.

Insofar as patents are of great and increasing value, and insofar as patents have historically been underexploited as assets particularly due to companies' inadequate understanding of their patents as well as other inefficiencies in the licensing or sale (or other transfer) of patents, there is a growing need for mechanisms and institutions that facilitate the licensing and sale of patents. Recently, various groups have begun to recognize this need and have begun to respond to it. In particular, several groups have begun to develop patent or intellectual property asset exchanges, which include (for example) Patent Auction, New Idea Trade, Technology Exchange, PatentCafe.com and yet2.com. Defunct IP exchanges include: PWC's IPEX, International Technology Exchange, PATEX, TechExchange Online, Global Licensing Exchange. Other types of IP exchanges include Patent & License Exchange (pl-x) which provides IP valuation & lifecycle management software, Tech Tuesday and University ventures which are online listings of technology from universities and research centres and Delphion which provides access to patent information and tools to help members take advantage of the information available. The development of such exchanges has been facilitated by the development of computers and telecommunications technologies generally, and the internet specifically. These exchanges provide markets or forums in which individuals owning intellectual property assets can place those assets up for licensing or sale. Others interested in licensing or purchasing intellectual property assets can then obtain information regarding, and eventually license or purchase, the intellectual property assets that are available for transfer. Such exchanges are somewhat analogous to bulletin boards, which provide forums in which companies with securities may be linked with individuals who desire to purchase securities.

In addition to the groups developing intellectual property asset exchanges and intellectual property asset management programs, some groups are developing intellectual property brokerages. The development of such brokerages, like the intellectual property asset exchanges, has been facilitated by the emergence of the internet. Some of these brokerages, such as DaVinci-Online™ and TTG/Newfuntiers focus primarily on acting as brokerages uniting individual inventors (who have ideas or, in relatively limited cases, actual patent rights) with persons who may desire to implement, purchase or license those ideas. Other brokerages, such as The Hook focus on acting as brokerages uniting companies with potential markets. The brokerages provide services including market analysis services (to determine the potential marketability of a client's ideas or patents), marketing services (including on-line display of information regarding clients' technologies), and searching for potential development partners and purchasers/licensees. The brokerages each operate by receiving up-front fees and/or commissions for the services they provide. The brokerages less frequently take equity interests in their clients, since the taking of such equity interests is a less reliable arrangement for earning income.

Although intellectual property asset exchanges and intellectual property brokerages are beginning to provide valuable services, each of these types of institutions has significant limitations in facilitating the licensing or sale of patents. With respect to intellectual property asset exchanges, such institutions are only in the beginning stages of their development into mature, efficient forums for the trading (licensing, selling and purchasing) of intellectual property assets. It remains to be seen whether such forums can radically or only partially streamline the process of putting together licensors and licensees, and buyers and sellers, of intellectual property assets, by reducing information barriers and various other risks.

Further, regardless of whether intellectual property asset exchanges are successful in providing more efficient forums in which to trade intellectual property assets, the effectiveness of such exchanges will always depend in large part upon the skills of those individuals who interact with the exchanges. Such persons will need skills in effectively placing information onto, obtaining information from, and interpreting information obtained from the exchanges. Further, such persons will require decision-making skills concerning trading on the exchanges, e.g., skills in determining when it is appropriate to in fact proceed with trades on the exchanges. Although some large corporations may have sufficient resources and incentive to develop the expertise necessary to operate in conjunction with the exchanges, without intermediaries, most small and mid-size corporations will require considerable assistance to operate in conjunction with the exchanges.

Intellectual property brokerages also are hindered by certain limitations that prevent their effective facilitation of intellectual property transfer. Although intellectual property brokerages sometimes take equity interests in their clients, generally such brokerages do not purchase, obtain licenses (including the rights to sublicense) in, or otherwise obtain intellectual property rights in the intellectual property of their clients. Rather, the intellectual property brokerages provide services to facilitate the sale, licensing or other development of their clients' intellectual property, and the brokerages are paid for their services by way of up-front fees or commissions. Consequently, intellectual property brokerages are hindered by a lack of certain incentives for employees (e.g., a lack of institutional mission) and a lack of flexibility. The employees of intellectual property brokerages do not typically obtain the individual satisfaction of “ownership” (or even a lesser possessory interest) in the intellectual property interests with which the brokerages are dealing, and the employees are not involved in any tangible “building-up of the enterprise” that could give the employees a special type of satisfaction and motivation. The brokerages and their employees must constantly adapt to the ever-changing, sometimes shortsighted demands of their clients.

Additionally, because the intellectual property brokerages lack ownership of intellectual property assets (or possession of interests in/rights to the intellectual property), the brokerages' value is determined almost exclusively by the talent of their personnel or “human capital.” As with respect to many service firms, this lack of identifiable assets can limit the brokerages' ability to raise capital (e.g., through public trading of the brokerages' stock on stock exchanges). This inability to raise capital in turn limits the brokerages' effectiveness in facilitating intellectual property transfer. As in the biotechnology industries, where identifying market needs and developing valuable, marketable products requires great expenditures sustained over long periods of time, the identification and development of opportunities for intellectual property transfer can require investments over a long period of item. Intellectual property transfer often is a complicated, risky business requiring significant patience. Because brokerages lack capital and must respond to the immediate demands of their clients, brokerages must constantly focus on developing the most obvious, easily-attainable, short-term opportunities for intellectual property transfer, and may ignore the more challenging (and often long-term) opportunities.

There are an increasing number of companies looking for ways of “sweating” their Intellectual Property (“IP”) assets, such as out-licensing their non-core technologies, copyrights or trademarks. However, out-licensing their non-core technologies would require either investment in internal resources or reliance on technology brokers, in which results have been shown to be varied especially in unfavourable economic situation where there are more sellers than there are buyers of IP. These companies would therefore be open to new alternatives of “sweating” their IP assets.

Most companies have limited resources to invest in non-strategic IP. An alternate source of funding these non-core research and development activities will therefore be attractive to such companies.

Furthermore, assets thin companies which are constantly searching for additional funding without the need to liquidate their assets would also find an alternate source of funding attractive.

A company may comprise of management team and board of directors to oversee the activities of the company, such as generating revenue from the commercialization of the intellectual property asset. However, any bad business management, shortage of funds, or lack of focus within the company can jeopardise any investment ventures. For instance, during the internet dot-com bust, many useful IP bundled within the business has actually gone to waste due to poor business management within the company. There are investors who are interested in investing only in the selected IP of the company. Therefore, investing solely on the technology of the company without any association to the incumbent management would be attractive to the investors.

Further, the existing systems have additional limitations as follows.
1. The investors in the technology can only participate as one of the following: (a) angel investors; (b) via a venture capital fund; (c) via mutual funds that invest in technology companies; and (d) retail investors on the stock exchanges.
2. The limitation is that other than in (d), there is very limited to absolutely no liquidity and little diversification.
3. IP owners may wish to put up their IP assets as collaterals but there are no agencies where lenders and credit providers can review documents that assign, grant, or convey rights related to the intellectual property assets; where the ownership, and encumbrances on the intellectual property assets can be verified.
4. Investment is invariably tied the IP with the business. Good technology/music/brands goes down with the business, and there is no efficient system that salvages good IP.
5. Current models are premised on transactions between the IP Owner as licensor, and one or more licensees. There is no constant buy and sell, or liquidity, which is the foundation of any exchange.
6. Licensees tend to obtain the license for actual use and not for speculation. As such, and given the heterogeneous nature of IP, plus the usually significant value of the transaction, transactions tend to be long in the making. This will impact liquidity.
7. Insufficient content to attract potential licensees lead to low level of transactions. Licensees and licensors would find themselves better off if they engaged a IP broker who would make searches and matches actively.
8. Unattractive fee structures, for instance, charges for searches and charges just to access the site.

Given the growing importance of intellectual property assets to companies, given that the value of intellectual property assets could be significantly enhanced by increased and more efficient licensing and sale of intellectual property assets, and given the limitations of intellectual property asset exchanges and intellectual property brokerages in facilitating intellectual property transfer via a central database, there exists a critical need for a method and system for facilitating the transfer of intellectual property such as the licensing and sale of patents, trademarks and copyrights. Further, because of the continuing development and increasing use of computer and telecommunications technologies generally, and the internet specifically, including the development and use of such systems by and in relation to the intellectual property asset exchanges, there exists at present a critical need for a system for facilitating intellectual property transfer that employs these modern computer and telecommunications technologies. The need is for, among other things, a system that employs these technologies for the purposes of efficiently interfacing with parties who would like to directly license, sell or purchase intellectual property assets (as well as the parties' representatives, who may include intellectual property brokerages), interfacing with the intellectual property asset exchanges, processing information obtained from each of these entities, and promoting the transfer of intellectual property assets among these parties.

From the above, it is apparent that it would be advantageous if there was a system in place that facilitated intellectual property transfer (where intellectual property transfer is understood broadly to encompass the transfer of any and all types of intellectual property assets, including patents, trademarks and copyrights). It would be additionally advantageous if such a system was capable of interfacing with companies or individuals who were interested in licensing or selling their intellectual property assets, and with companies or individuals who were interested in licensing (or sublicensing) or purchasing others' intellectual property assets. It would further be advantageous if such a system was capable of streamlining the processes of licensing and selling patents such that the processes (and operation of the system itself) were quick, easy to understand and implement (e.g., standardized), and inexpensive to use, for financial institutions, investors, potential licensors, licensees, sellers and buyers of patents. It would additionally be advantageous if such a system was cap able of addressing the needs of many different parties with respect to the transfer of many different patents, in a rapid, efficient manner.

It would be further advantageous if such a system was cap able of interfacing with the emerging computer-based, internet-oriented intellectual property asset exchanges to allow for licensing and selling of IP on those exchanges in an efficient, inexpensive and reliable manner. It would further be advantageous if such a system was not hindered by the constraints affecting intellectual property brokerages, including overly-demanding clients, a lack of mission for its employees, a lack of capital, or a lack of flexibility (in particular, to pursue long-term, but profitable, opportunities for the transfer of intellectual property). It would additionally be advantageous if such a system was fast-operating, easy to use, and inexpensive to use and operate, by potential licensors, licensees, sellers and buyers of patents, trademarks and copyrights, in relation to the intellectual property asset exchanges. It would be further advantageous if such a system was capable of facilitating a multiplicity of different types of intellectual property transfer arrangements involving a multiplicity of different types of licensors, licensees, sellers and buyers.

It would be further advantageous to provide a revolutionary way of extracting value from IP, that is, companies can raise funds by letting people invest and speculate in their IP instead of in their company. This decoupling cushions the comp any from speculation risks. It would further be advantageous if the fund raising is not limited to sale of Right-to-Value (RV), the IP Owner can still license their IP as long as the Right-to-Use (RU) still remains with them. It would further be advantageous if the investors can include anyone and everyone ranging from the institutional investor to the man in the street, just as with the stock exchange.

It would be further advantageous if such a system was cap able of storing, issuing, lodging, recording, and transferring of IP assets. By allowing financial institutions and market participants to obtain up-to-date information related to ownership, encumbrances, right-to-use and value of the trading security units on IP assets, IP owners could use IP as collateral for loan or credit facilities. By allowing the providers of capital to review documents that assign, grant, or convey rights related to the intellectual property assets from a central database, they can ascertain the ownership, and encumbrances on the intellectual property assets before decisions are made.

The lack of such a agency that can provide a convenient, efficient and reliable means to record and up date, through one system, the essential information on IP assets creates insecurity and risk to capital market participants and increases the cost of capital to IP owners.

Other objectives of the present invention include:
1) Creates liquidity for IP trading (measured by how easily a IP owner can acquire or dispose of a trading unit of IP asset).
2) An owner of a large portfolio of IP may offer non-core IP for trading on the IP exchange thereby creating returns for non-performing assets.
3) An IP Owner who is in need of funds can offer the Right to Value of his IP for trading on the Exchange. IP Owner gets cash when he initially lists the IP. IP Owner retains Right to Use on his IP for further research and development and commercialization.
4) IP Owner is still free to out-license the IP as he retains the Right to Use.
5) Offers investors an alternative financial instrument for short to mid term, high risk investments. Investors now have the ability to invest in specific IPs, instead of the whole company.
6) Allows for diversified investments into emerging IPs, whether for financial or strategic purposes.
7) Attracts a broader spectrum of investors into the space. Retail investors now have the ability to invest in high growth opportunities.
8) Generates opportunities for a whole host of supporting service providers.
9) Create a convenient, efficient, and reliable means to settle IP transactions.
10) Allows financial institutions and market participants to obtain up-to-date information related to ownership of, encumbrances, right-to-use and value of the trading security units on IP assets.
11) Allows IP owner to use IP as collateral for loan and credit facilities from financial institutions.

Other objects and advantages of the present invention will become apparent from the following description, taken in connection with the accompanying drawings, wherein, by way of illustration and example, an embodiment of the present invention is disclosed.

### SUMMARY OF THE INVENTION

In accordance with a first aspect of the present invention, a system to lodge, issue, store, record, transfer, review and trade one or more security units associated with intellectual property (“IP”) assets, the system comprising:

a. providing a server coupled to a graphical user interface by which at least one other. party can query and receive information on intellectual property assets;

b. providing an input device for receiving a request for information from a querying device or computer system for information on intellectual property assets;

c. providing an output device of the system that presents information related to right-to-use, encumbrances, ownership, and price of the trading security units on intellectual property assets gathered from its database;

d. receiving, recording and storing of intellectual property assets in the server;

e. issuing of trading security unit associated with intellectual property assets, the trading security unit having a tradable identifier and a non-tradable identifier;

f. transferring the non-tradable identifier to at least one other party;

g. selecting at least one group of data from the server, the server transferring and transmitting the non-tradable identifier to the graphical user interface and a plurality of devices;

h. selecting at least one group of data from the server, the server issuing and transmitting the tradable identifier to the graphical user interface and a plurality of devices; and

i. formatting at least one group of data for transmission to an order entry system of an intellectual property exchange, the formatting involving converting each item of the selected at least one group of data from the server into corresponding variable for insertion into a previously programmed list of commands of an order entry system of the intellectual property exchange.

### BRIEF DESCRIPTION OF THE DRAWINGS

By way of example/illustration only, an embodiment of the invention is described more fully hereinafter with reference to the accompanying drawings, in which:

FIG. 1 is a block diagram which illustrates how the depository server 101 facilitates the issue, lodgement, storage, custody, recording, transfer and trading one or more security units associated with intellectual property (“IP”) assets; and its relationships with IP exchanges 102, financial institutions 103, IP owners 104, special purpose entities 105, market participants 106, licensees 107, national patent offices 108, and service firms 09.

FIG. 2 is a block diagram and flow chart which illustrates schematically how the present invention 00 operates as an input device for receiving a request for information from a querying device for assessment of the information on IP security units.

FIGS. 3 to 5 shows the details of the graphical user interface 109 that is been displayed.

### DETAILED DESCRIPTION

A new system is presented for facilitating the lodgement, storage, issue, custody, record, transfer and trade of one or more security units associated with intellectual property (“IP”) assets. The invention includes an input device for receiving a request for information from a querying device for assessment of the information on IP assets. The system has a querying mechanism for requesting and receiving information various third party devices. An output device of the system presents at information gathered from its database. In an embodiment of the system, the information from the querying device is related to right-to-use, encumbrances, ownership, and price of the trading security units on IP assets.

The current market for intellectual property and sophistication of the exchanges provide an opportunity to develop efficiencies in the IP marketplace and maximize IP valuation through an IP trading exchange. An IP trading exchange may be used for licensing or selling all types of IP, including patents, copyrights, trademarks, trade dress, and trade secrets. The new system helps overcome the lack of a central depository where the information related to ownership of, encumbrances, right-to-use and value of the trading security units on IP assets can be stored and retrieved.

In one embodiment of the present invention, the IP may include issued patents, registered copyrights, registered trademarks, or any other granted or registered IP. In another embodiment of the present invention, the IP may include pending patent applications, pending trademark applications, or any other pending IP application or registration.

In accordance with an embodiment of the present invention, an Intellectual Property (IP) trading platform offers a forum in which IP owners 104, licensees 107, or financial institutions 103 or market participants 106 may buy or sell IP rights through licenses and/or related financial instruments. For example, in accordance with one embodiment of the present invention, a depository server 101 may be used to buy or sell IP rights through licenses, which may then be used to practice the invention or legitimize current operations that may be infringing. In accordance with another embodiment of the present invention, an IP exchange 102 may be used to buy or sell speculative IP rights through a trading unit, a share, participation or interest in property, rights or an enterprise of an issuer, an obligation of an issuer, any right to acquire such share, participation, interest or obligation of a type commonly recognised as a medium for investment or dealt in upon an exchange or organised market including a derivative instrument and includes uncertificated securities.

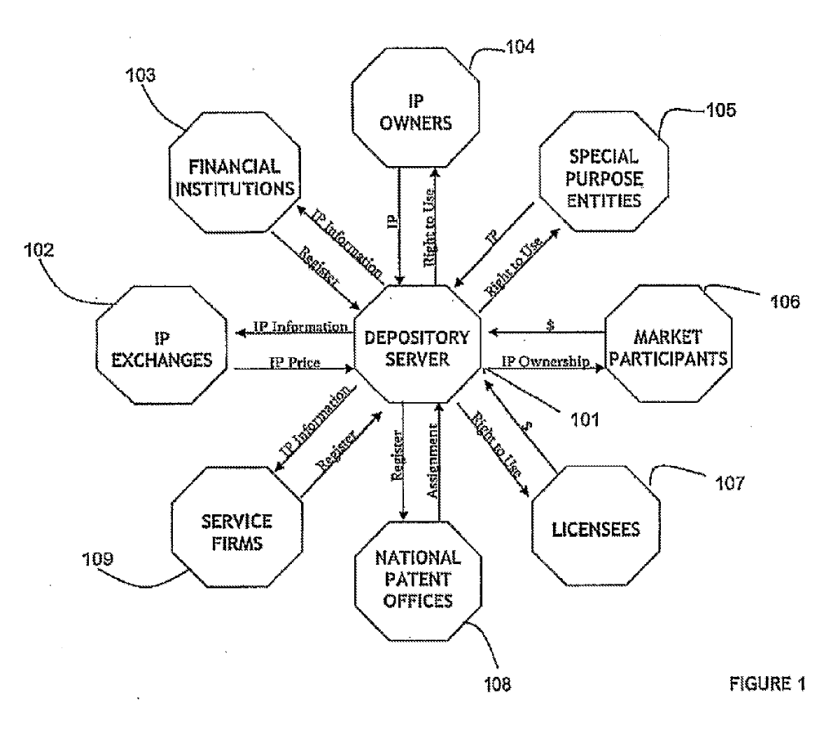

An embodiment of the present invention, a depository server 101 offers a place for the storage, issue, lodgement, custody, recording, transfer and trading of IP assets. The depository server 101 operates in a fashion that is analogous to a central depository that documents evidencing title to securities (eg, Right-to-Use and Right-to-Value), whether or not listed on the IP exchanges 102 (with where applicable, in the case of shares, or registered debentures, proper instruments of transfer duly executed), are deposited and are registered in the name its nominee; and may also provide a settlement and clearing service in relation to eligible securities. Securities accounts may also be maintained by the depository server 101 in the names of the depositor so as to reflect the title of the depositors to the deposited securities. The depository server 101 includes an input device for receiving a request for information from a querying device for assessment of the information on trading IP security units. The system has a querying mechanism for requesting and receiving information from the financial institutions and market participants. An output device of the system presents at information gathered from the depository server 101 database. In an embodiment of the system, the information from the querying device is related to encumbrances, ownership, right-to-use and value of the trading security units on IP assets. As presented in FIG. 1, a new system is shown for the review, storage, issue, lodgement, custody, recording, transfer and trading one or more security units associated with intellectual property (“IP”) assets. The new system, the depository server 101 helps overcome the constraints of the current limitations faced by intellectual property stakeholders such as the IP exchanges 102, financial institutions 103, IP owners 104, special purpose entities 105, market participants 106, licensees 107, national patent offices 108, and service firms 109 by acting as a central database where information can be stored and retrieved. IP rights can be assigned to and lodged by the IP owner 104 and special purpose entity 105 to the depository server 101 via national patent offices 108, service firms 109 (legal and audit professionals) and financial institutions 103 electronically. The depository server 101 will in turn issue a license the IP (right to use) back to the respective IP owner 104 and special purpose entities 105 for IP under its custody. A trading unit is created from the IP and information is passed on to IP exchanges 02 for trading. Licensees 107 who are interested in the IP can access the depository server 101 to inquire on the last traded price, ownership structure, revenue from licensing, royalty fees and other pertinent information related to the IP in question. The depository server 101 may license the IP to licensees 107 for a fee. This information will be recorded in the depository server 101 database. Market participants 106 who wish to invest in the trading security units on IP assets can also access the depository server 101 to extract information on the relevant IP assets Financial institutions 103 and providers of credit may also log in to the depository server 101 to perform a review on ownership and encumbrances on IP assets pledged by IP owners 104 in exchange for credit or loan facilities. The financial institutions 103 may register its claim on the relevant IP assets electronically via the depository server 101.

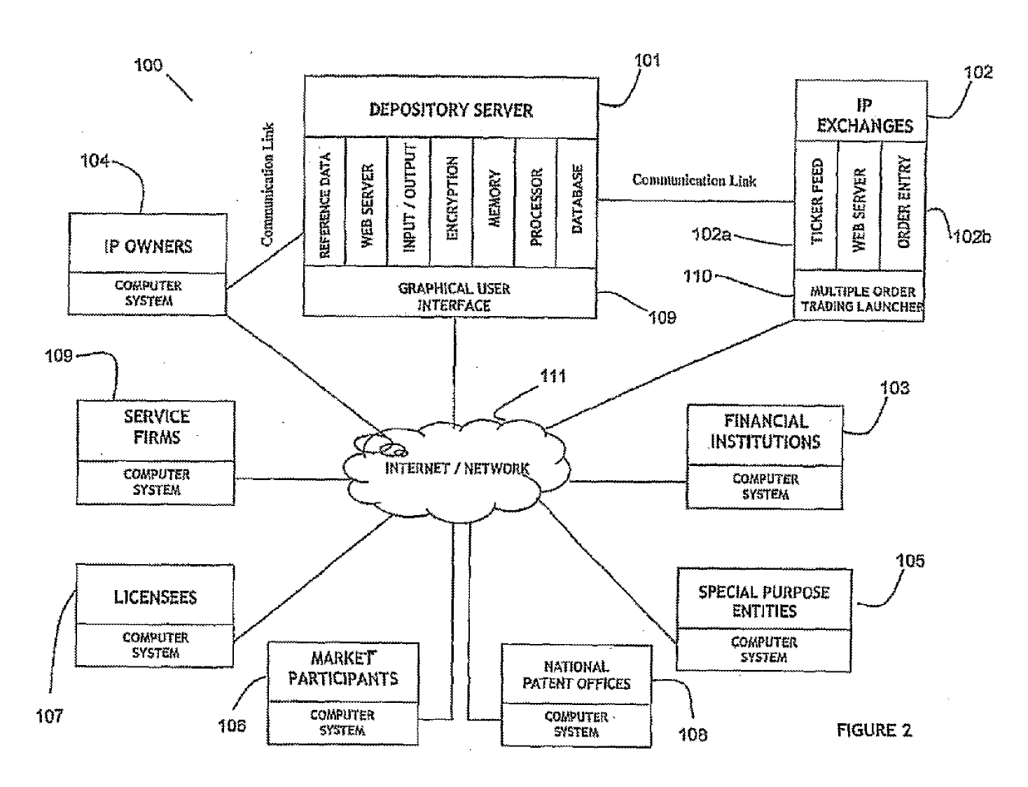

As shown, FIG. 2 is a block diagram and flow chart which illustrates schematically how the present invention 100 facilitates the storage, issue, lodgement, custody, recording, transfer and trading one or more security units associated with intellectual property (“IP”) assets. In the diagram the web server of the IP exchange is shown at 02 and includes a ticker feed system 102a which constantly generates updated data on the prices and volumes of various security units associated with the intellectual property assets (“security unit”) being traded, and delivers the updated data to depository server 101 where the data is stored and accessible to any terminals which are connected to the network (there may be other forms of communication links, including direct hardwire connection and other forms of connections).

The depository server 101 issues the security units associated with the intellectual property assets lodged by the special purpose entity 105, financial institution 103, or IP owner 104. The special purpose entity 105 may be a company intending to list their intellectual property assets for trading purposes. The security unit may comprise of a tradable identifier and a non-tradable identifier. The non-tradable identifier is associated with right-to-use while the tradable identifier is associated with right-to-value. The depository server 101 transmit the non-tradable identifier of the security unit back to the special purpose entity 105/IP owner 104 and also transmit the tradable identifier of the security unit to the graphical user interface 109 and IP exchange 102.

After the tradable identifier of the security unit is transmitted to the graphical user interface 109, the information of the security unit is displayed and designed to read and display a given basket of security units with the pertinent data with respect to volumes, bid, offer, last, etc. A display, such as a graphical user interface 109, is also provided to enable the information to be displayed to an interested party via the internet 111, such as the financial institutions 103 and market participants 106. The multiple order trading launcher 0 is coupled to the order entry 102b and ticker feed 102a for receiving data from the depository server 101, querying and selecting at least one group of data, formatting the selected at least one group of data for transmission to an order entry system 102b of the IP exchange 102. The formatting involves converting each item of the selected at least one group of data from the depository server 101 into corresponding variable for insertion into a previous programmed list of commands of an order entry system 102b of the IP exchange 102 and transmitting the formatted selected at least one group of data to the IP exchange 102.

Block 110 represents the multiple order trading system of the present invention which collect and reads trading inputs from an interested party via the internet 111, such as the financial institutions 103 and market participants 106, including all the data on a given basket of security units, organizes the data into the proper format for automated trading, and issues the multiple orders to the order entry system 102b of the central computer at the IP exchange 102. By having the data formatted by the multiple order trading launcher 110, the transaction of a whole basket of security units can be effected quickly and easily and with fewer errors and within the time frame for which the criterion or instructions for the transaction are valid. By providing a means, such as the depository server 101 which contains the necessary data on a group of security units, the multiple order trading launcher 110, which is capable of capturing all the trading inputs, selecting what is required, and organizing it into the form of an order, the present invention creates a bridge between the depository server 101 and the various stakeholders such as IP exchanges 102, financial institutions 103, IP owners 104, special purpose entities 105, market participants 106, licensees 107, national patent offices 108, and service firms 109. which effects a transaction in the trading of security units.

Furthermore, with the built-in processor, input/output devices, web server, reference data, memory, encryption and database, the depository server 101 can issue, lodge, store, take custody of, record, transfer and trade by managing and formatting the data more quickly and correctly than an operator on a keyboard, it is capable of effecting a transaction within the time and parameters which are rapidly changing, in a manner which an operator could not accomplished. Therefore, instead of merely processing data, it is capable of activating and controlling security units transactions. In this respect, depository server 101 may be adapted to initiate a transaction automatically when certain criterion are met, or may be designed to create a signal when the criterion are met so that a trader/operator may make the final decision or judgment to execute the transaction or not, and may then execute it substantially instantaneously once the decision has been made via IP exchanges 102.

The data is received from the IP exchange 102 in real time. Once the order entry has been received by the IP exchange 102, the transaction is completed and the appropriate records and confirmation documents are produced in the usual manner by depository server 101 without any further activity by the market participants 106.

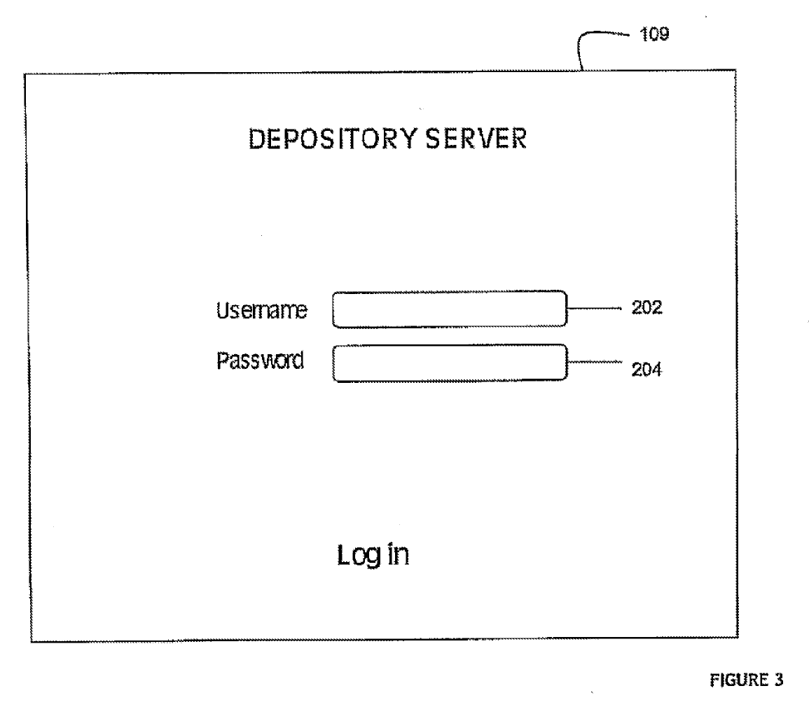

FIGS. 3 to 5 shows the screen shots of the graphical user interface 109 during trading and query operations. As shown in FIG. 3, when in use, an interested party may log into the depository server 101 by entering the user name 202 and password 204.

An interface may be coupled to the controller by the third parties in which the interface will interact with the graphical user interface 109 and affect the selecting, formatting and transmitting by the controller.

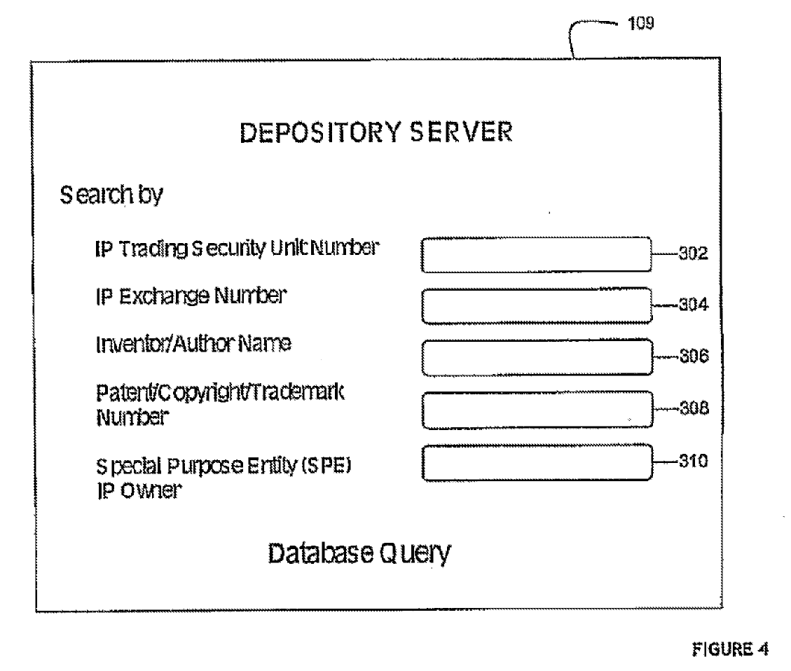

Once the third party logs onto the depository server 101, the graphical user interface 109 will display the database query page as shown in FIG. 4. As shown in FIG. 4, the third party may be prompted to enter at least one predetermined parameters, such as the IP trading security unit number 302, global IP exchange number 304, inventor/author name 306, patent/copyright/trademark number 308 and special purpose entity name 310. The graphical user interface 109 may also includes representatives of symbol, price, order size and transaction type.

At least one group of data may be selected based on at least one predetermined parameters, such as such as the IP trading security unit number 302, global IP exchange number 304, inventor/author name 306, patent/copyright/trademark number 308 and special purpose entity name 310.

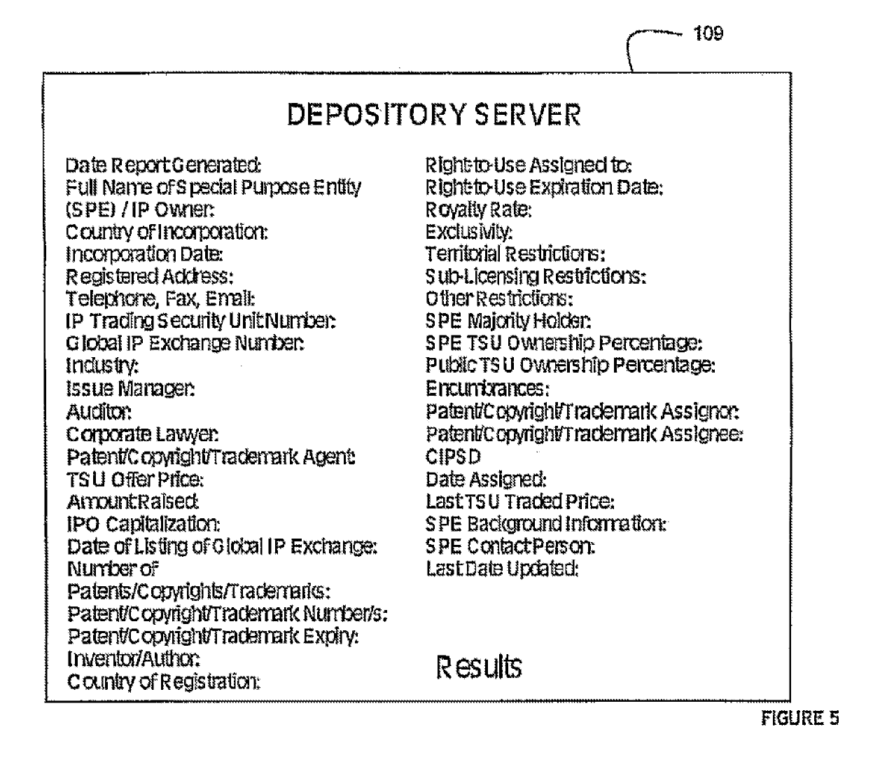

The depository server 101, using the information provided by third party users such as IP exchanges 102, financial institutions 03, IP owners 104, special purpose entities 105, market participants 106, licensees 107, national patent offices 108, and service firms 109, queries its database and captures the matching records for display at the graphical user interface 109. The depository server 101 has a fuzzy logic system to increase the likelihood of locating a record where the data is mistyped on the query to show a list of possible IP assets. Thereafter, the graphical user interface 109 will display the database result page as shown in FIG. 5.

It has been shown that the new system is capable storing, issuing, lodging, recording, transferring and trading of one or more security units associated with intellectual property (“IP”) assets. The invention is meant to include all systems that facilitate the storage, issue, lodgement, record, transfer and trade of one or more security units associated with intellectual property (“IP”) assets; not all of the query, process or data entry method is required for proper function of the system. The invention is meant to function and encompass any form of combinations of sequence described above.

While the invention has been particularly shown and described with respect to a preferred embodiment thereof, it will be understood by those in the art that various changes in form and details can be made therein without departing from the spirit and scope of the invention. It will be appreciated by those skilled in the art that changes could be made to the embodiments described above without departing from the broad inventive concept thereof. It is understood, therefore, that this invention concept is not limited to the particular embodiments disclosed, but it is intended to cover modifications within the spirit and scope of the present invention as defined by the appended claims. Thus the scope of the invention should be determined by the appended claims and their legal equivalent, rather than by the examples given.

What is claimed:

1. A method to lodge, issue, store, record, transfer, review and trade one or more security units associated with intellectual property (“IP”) assets, the method comprising:
a. providing a server coupled to a graphical user interface by which at least one other party can query and receive information on intellectual property assets;
b. providing an input device for receiving a request for information from a querying device or computer system for information on intellectual property assets;
c. providing an output device of the system that presents information related to right-to-use, encumbrances, ownership, and price of the trading security units on intellectual property assets gathered from its database;
d. receiving, recording and storing of intellectual property assets in the server;
e. issuing of trading security unit associated with intellectual property assets, the trading security unit having a tradable identifier and a non-tradable identifier;
f. transferring the non-tradable identifier to at least one other party;
g. selecting at least one group of data from the server, the server transferring and transmitting the non-tradable identifier to the graphical user interface and a plurality of devices;
h. selecting at least one group of data from the server, the server issuing and transmitting the tradable identifier to the graphical user interface and a plurality of devices; and
i. formatting at least one group of data for transmission to an order entry system of an intellectual property exchange, the formatting involving converting each item of the selected at least one group of data from the server into corresponding variable for insertion into a previously programmed list of commands of an order entry system of the intellectual property exchange.

2. The method according to claim 1, wherein the party includes at least an intellectual property exchange, national patent office, market participant, financial institution, special purpose entity, licensee, service firms or intellectual property owner, and wherein the intellectual property asset includes at least one of patents, copyrights, trademarks, trade dress, and trade secrets.

3. The method according to claim 1, wherein the server includes a plurality of computer systems and web pages that form at least a portion of the graphical user interface.

4. The method according to claim 1, wherein at least one parameter that is being queried is selected from the group of data consisting of information on encumbrances, ownership, right-to-use and value of the trading security units on intellectual property assets.

5. The method according to claim 3, wherein the server is capable of recording, storing and the assignment of intellectual property assets from at least one of intellectual property exchange, national patent office, market participant, financial institution, special purpose entity, licensee, service firms or intellectual property owner.

6. The method according to claim 1, wherein the tradable identifier is associated with right-to-value and the non-tradable identifier is associated with right-to-use.

7. The method according to claim 6, wherein the server issues and transfers the right-to-use portion (ie, the non-tradable identifier) of the intellectual property asset to an intellectual property exchange, national patent office, market participant, financial institution, special purpose entity, licensee, service firms or intellectual property owner.

8. The method according to claim 7, wherein the server transmits the non-tradable identifier to an intellectual property exchange, national patent office, market participant, financial institution, special purpose entity, licensee, service firms or intellectual property owner.

9. The method according to claim 8, wherein the server transmits the data on the right-to-value portion (ie, the tradable identifier) of the intellectual property asset to an intellectual property exchange, national patent office, market participant, financial institution, special purpose entity, licensee, service firms or intellectual property owner in real time.

10. The method according to claim 1, wherein the formatted selected at least one group of data is transmitted based on at least one predetermined parameter.

11. The method according to claim 10, wherein the predetermined parameters includes the trading security unit identifier, intellectual property exchange number, inventor/author name, patent/copyright/trademark number and special purpose entity or intellectual property owner name.

12. The method according to claim 1, further comprising an a server coupled to a graphical user interface by which at least the graphical user interface includes at least one field for receiving input information for selecting, formatting and transmitting by the server.

13. The method according to claim 12, wherein the graphical user interface refers to a graphic display.

14. The method according to claim 13, wherein the graphic display includes representations of symbol, price, order size and transaction type.

15. The method according to claim 1, wherein the secured interacting includes the prior input of identification data such as user name and password.

16. The method according to claim 1, wherein the formatting at least one group of data for transmission to an order entry system of an intellectual property exchange, the formatting involving converting each item of the selected at least one group of data from the server into corresponding variable for insertion into a previously programmed list of commands of an order entry system of the intellectual property exchange is performed in real time.

17. The method according to claim 1, wherein the server can lodge, issue, store, record, review and transfer one or more intellectual property assets through licensing and royalty fees to a market participant, financial institution, special purpose entity, licensee, service firms or intellectual property owner, which may then be used to practice the invention or legitimize operations that are infringing.

18. The method according to claim 1, wherein the server can lodge, issue, store, record, transfer, review and trade one or more intellectual property assets such as a trading unit, a share, participation or interest in property, rights or an enterprise of an issuer, an obligation of an issuer, any right to acquire such share, participation, interest or obligation of a type commonly recognized as a medium for investment or dealt in upon an exchange or organized market including a derivative instrument and includes uncertificated securities.
